(19) United States
(12) Patent Application Publication
(10) Pub. No.: US 2015/0135974 A1
(43) Pub. Date: May 21, 2015

(54) RECIRCULATING WATER DEFROSTER

(71) Applicants: Rudy Ambrosi, Marina Del Rey, CA (US); Mark V. Pinto, Naples, FL (US)

(72) Inventors: Rudy Ambrosi, Marina Del Rey, CA (US); Mark V. Pinto, Naples, FL (US)

(21) Appl. No.: 14/081,682

(22) Filed: Nov. 15, 2013

(51) Int. Cl. F25D 21/10; A47J 36/24

(52) U.S. Cl. CPC F25D 21/10; A47J 36/24
USPC 99/483

(57) ABSTRACT

Systems and methods are disclosed for a recirculating water defroster that dispenses, collects, and recirculates water to defrost food. The recirculating water defroster may include a water dispenser unit, a water pump, and a food placement unit. The water dispenser unit connects to the water pump to dispense water over food placed on or in the food placement unit. The water runs over the food to defrost the food and may be collected in a tub. The water pump recirculates the water collected in the tub to the water dispenser. The volume of water being recirculated may be controlled through the water pump. The water pump may also have a water filtration unit. The recirculating water defroster may be portable or may be integrated with the tub, where the water pump may be located inside or outside the tub. The water pump may be integrated with the food placement unit.

### BACKGROUND OF THE INVENTION

1. Field of the Invention

The present invention relates generally to systems and methods for recirculating water. In particular, the present invention relates to systems and methods for recirculating water to defrost food or to change the temperature of food.

2. Discussion of the Related Art

Food preparation frequently requires changing the temperature of food prior to the actual cooking of the food. For example, frozen proteins (e.g., beef, pork, poultry, and fish) need to be defrosted or thawed to the correct state prior to cooking them properly. Conventionally, food is defrosted by continuously running cold tap water over the frozen food product sealed in a bag and placed in an open vessel until the temperature of the food is brought to the proper state. As the tap water runs over the food, heat transfer takes place to gradually increase the temperature of the food. However, because heat transfer from the water to the food tends to be slow, with the possible exception of the smallest food items, defrosting food using freely running water is highly inadequate. This is because the surface area of the food involved in heat transfer relative to the total surface area of the food may be small and/or the food may have a low surface area/volume ratio. As a result, it may take an inordinate amount of time to defrost the food, wasting enormous amounts of water and increasing the cost of food preparation. For example, a 10 pound frozen turkey may take an hour to defrost under running tap water, needlessly wasting thousands of gallons of water. One may be tempted to immerse the food in standing water to reduce water waste. However, health regulations and food safety concerns may prevent the food from sitting in water for an extended period of time. In addition, the speed of heat transfer may be even slower in non-moving water compared to moving water. Thus, water may have to be frequently changed, requiring manual intervention and offsetting any potential water savings. As such, there is a need for a system that defrosts food efficiently, effectively and that also conserves precious water resources.

### SUMMARY

According to one embodiment of the present invention, a recirculation water defroster is provided. The recirculation water defroster includes a water pump used to pump water taken in from an inlet to deliver water to an outlet of the water pump. The recirculation water defroster also includes a water dispenser unit. The water dispenser unit is connected to the outlet of the water pump to deliver the water pumped from the water pump to an opening of the water dispenser unit. The recirculation water defroster further includes an object placement unit used to hold an object that receives water dispensed from the opening of the water dispenser unit. The object is positioned above the water level. The water dispensed from the water dispenser unit runs over the object, is collected and is taken up through the inlet of the water pump to be recirculated.

According to one embodiment of the present invention, the recirculation water defroster further includes a tub used to collect the water to be recirculated. The water pump is placed inside the tub.

According to one embodiment of the present invention, the recirculation water defroster further includes a tub used to collect the water to be recirculated. The water pump is placed outside the tub.

According to one embodiment of the present invention, the object placement unit integrates a tub, a reservoir, or a chamber used to collect the water to be recirculated.

The present invention is better understood upon consideration of the detailed description below and the accompanying drawings.

### BRIEF DESCRIPTION OF THE DRAWINGS

FIG. 1 shows a perspective view of a recirculating water defroster placed inside a tub to defrost food placed on a grate in accordance with one embodiment of the present invention;

FIG. 2 shows a perspective view of a recirculating water defroster that is integrated within a tub to defrost food placed on a grate where the water pump is located inside the tub in accordance with one embodiment of the present invention;

FIG. 3 shows a perspective view of a recirculating water defroster that is integrated with a tub to defrost food placed on a grate where the water pump is located outside the tub in accordance with one embodiment of the present invention;

FIG. 4 shows a perspective view of a recirculating water defroster that integrates the food placement unit and the water pump in a portable unit to defrost food placed in the food placement unit in accordance with one embodiment of the present invention; and

FIG. 5 shows components of a water pump of a recirculating water defroster in accordance with one embodiment of the present invention.

To simplify and facilitate the detailed description, like elements in the figures are assigned like reference numerals.

### DETAILED DESCRIPTION OF THE PREFERRED EMBODIMENTS

Systems and methods are disclosed for a recirculating water defroster that dispenses, collects, and recirculates water to defrost food. The recirculating water defroster may include a water dispenser unit, a water pump, and a food placement unit. The water dispenser unit connects to the water pump to dispense water over food placed on or in the food placement unit. The water runs over the food to defrost the food and may be collected in a tub. The water pump recirculates the water collected in the tub to the water dispenser unit. The volume of water being recirculated may be controlled through the water pump. The water pump may also have a water filtration unit to filter food particles and other compounds or impurities found in the collected water.

The recirculating water defroster may have a variety of configurations suitable for use in different applications. For example, the recirculating water defroster may be configured as a portable unit with the water pump attached to the water dispenser unit in an assembly, a separate food placement unit and without the tub. In one or more embodiments, the recirculating water defroster may be configured as a portable unit with the water pump/water dispenser unit assembly integrated with the food placement unit where the food placement unit may also function as a tub. In one or more embodiments, the recirculating water defroster may be configured as a fixture with the water pump/water dispenser unit assembly integrated with the tub. When the recirculating water defroster integrates the water pump/water dispenser unit assembly with the tub and is used as a fixture, the water pump may be integrated inside or outside the tub. The recirculating water defroster defrosts food effectively, efficiently, and economically while eliminating unnecessary water waste. The recirculating water defroster may be used to defrost or change the temperature of non-food objects. In these applications, the food placement unit may be referred to as an object placement unit for holding the object.

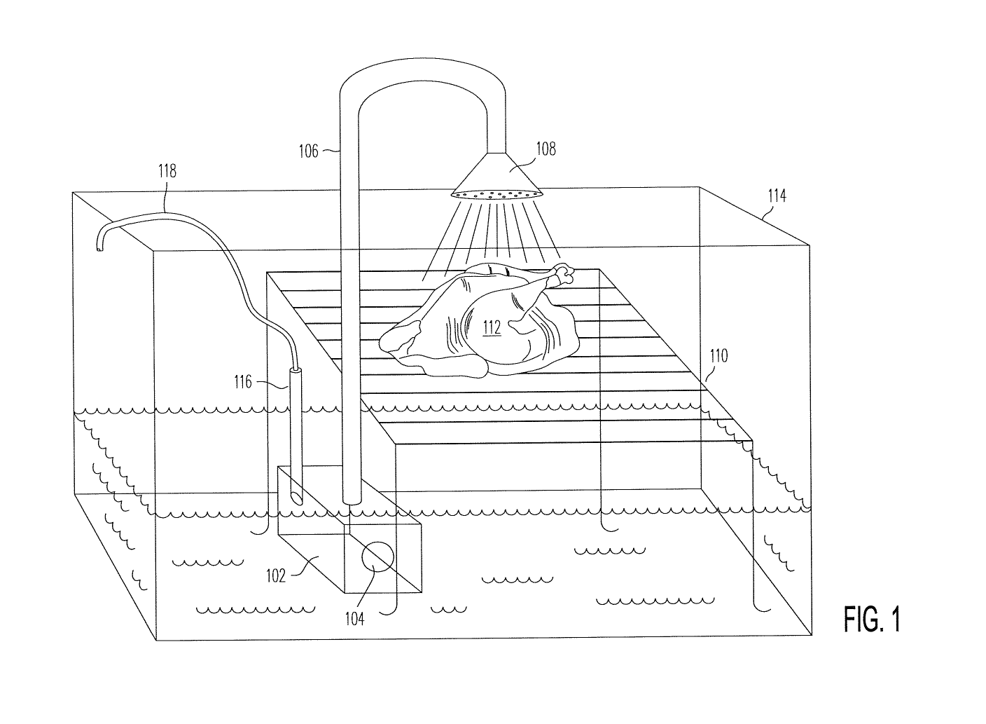

FIG. 1 shows a perspective view of a recirculating water defroster placed inside a tub to defrost food placed on a grate in accordance with one embodiment of the present invention. The recirculating water defroster includes a water pump 102, a water pipe 106, a spout 108, and a grate 110. Water pipe 106 and water spout 108 form the water dispenser unit that dispenses water delivered from water pump 102 to food 112 placed on grate 110. Water pipe 106 may be disassembled from water pump 102 to make the recirculating water defroster more portable and also to allow the installation of water pipe 106 of different length and shape to fit different applications. Spout 108 may also be unattached from water pipe 106 to allow the attachment of heads that have different spray patterns, in much the same way that different shower heads may be attached to a shower pipe. Spout 108 may also have adjustable settings to allow the water to be dispensed with different volume, burst patterns, and/or spray patterns, etc. For example, spout 108 may provide a fine mist, a low volume spray, or a heavy stream of water.

The recirculating water defroster may be assembled and placed in a tub 114. Tub 114 may be a kitchen sink, a wash basin, or other type of container used to collect water. Water pump 102 may be attached to the bottom of tub 114 with suction cups or other types of fastening devices to keep water pump 102 stationary. In one or more embodiments, water pump 102 may be held in place using dead weights or by its own weight. Grate 110 foams the food placement unit that may be positioned in tub 114 to hold food 112 under spout 108. The food may be sealed in a plastic wrap, a sealed bag, or other coverings to prevent the water from directly touching the food while allowing the heat transfer to take place between the water and the food. Grate 110 may have legs to allow the grate 110 to be raised above the water level. In one or more embodiments, the legs may be extended or retracted to adjust the height of grate 110. Grate 110 may have a porous surface or may have openings through which water may flow into tub 114. The openings may be small such as those formed by a fine mesh of wires or large such as those found in a gridiron.

Tub 114 may be partially filled with water so that water pump 102 is submerged but the water level stays below grate 110. Water pump 102 has an inlet hole 104 for water intake. In one or more embodiments, water pump 102 may have a filtration system to filter the recirculated water. An electrical feed tube 116 may extend upward from water pump 102 so that an opening of electrical feed tube 116 lies above the water line. Electrical feed tube 116 may provide a conduit through which power cord 118 may be run to provide electrical power to water pump 102. Water pump 102 may be turned on to recirculate water in tub 114. In one or more embodiments, water pump 102 may have different power settings to control the volume of water recirculated in a given time. Water pump 102 may also be controlled to run for a programmable period. The controls may be located in a control panel separate from water pump 102 if water pump 102 is submerged in water. In one or more embodiments, the control signals may be wirelessly transmitted to water pump 102. In operation, water pump 102 takes in water through inlet hole 104 and recirculates water through water pipe 106 to spout 108. Water rains down on food 112, flows through grate 110, collects in tub 114, and is taken up again by water pump 102 to be recirculated. The recirculating water defroster is portable and may be removed from tub 114 when the defrosting operation is complete. The water used in the recirculating water defroster is typically cold tap water. Due to the heat transfer from the tap water to food 112 during the defrosting process, the temperature of the recirculating water may not increase or may increase only slightly even if the ambient air temperature is warmer.

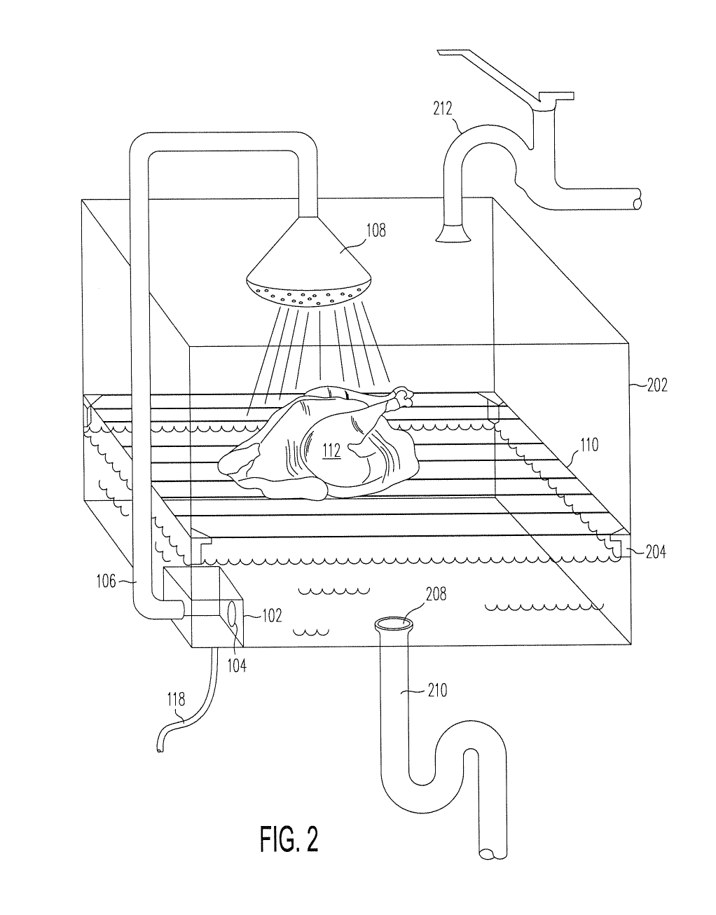

FIG. 2 shows a perspective view of a recirculating water defroster that is integrated within a tub to defrost food placed on a grate where the water pump is located inside the tub in accordance with one embodiment of the present invention. In contrast to the portable recirculating water defroster of FIG. 1, the recirculating water defroster in FIG. 2 may be used as a fixture when the tub is installed as a sink and connected to a drainage hookup. The fixture offers the advantage of a larger water recirculation capacity over a portable unit for defrosting larger food items. It may find applications in a commercial setting such as in restaurant kitchens.

Water pump 102 is affixed to a corner of tub 202. In one or more embodiments, water pump 102 may be installed in other locations in tub 202. Water pump 102 has inlet hole 104 for water intake as in FIG. 1. Water pump 102 may also have a filtration system. Water pipe 106 connects to water pump 102 through a side opening of tub 202. A gasket or a ring may be used to form a tight seal between water pipe 106 and the opening to prevent water leakage from tub 202. Power cord 118 connects to water pump 102 through another opening at the bottom of tub 202 to supply electrical power to water pump 102. A gasket or a ring may again be used to form a seal between power cord 118 and the bottom opening. Water pipe 106 extends upward externally to tub 202 to connect with spout 108. In one or more embodiments, water pipe 106 may be located inside of tub 202. Water pipe 106 or spout 108 may be detached and the water dispenser unit may be configured with pipes and/or spouts of different sizes, lengths, capacities, spray patterns, etc. In one or more embodiments, a water dispenser unit comprising of multiple spouts 108 may be configured to simultaneously defrost multiple food items. In one or more embodiments, water pump 102 may be configured with multiple water pipes 106 to supply water to multiple spouts 108. Tub 202 is connected to a drainage pipe 210 through a drainage opening 208. Grate 110 forms the food placement unit onto which food 112 is placed. Grate 110 is removable from tub 202 and is supported by welds 204 or support fixtures placed along the inside surface of tub 202, such as at the four corners. In one or more embodiments, hanging slots may be fabricated at different heights along the four corners of tub 202 for use in hanging welds 204. Welds 204 may be hung on hanging slots of different heights to adjust the height of grate 110.

Before operating the recirculating water defroster, drainage opening 208 may be plugged and water may be supplied from a fill spigot 212 to partially fill tub 202 to a level such that the water submerges water pump 102 but the water surface is below grate 110.

Water pump 102 may be controlled as before to recirculate water collected in tub 202 through inlet hole 104, up through water pipe 106 to spout 108. In one or more embodiments, water pump 102 may have a control panel affixed to the side of tub 202 to turn on/off water pump 102 and/or to control speed, duration, etc. of its operation. Water rains down on food 112, flows through grate 110, collects in tub 202, and is taken up again by water pump 102 to be recirculated. When the defrosting operation is complete, drainage opening 208 may be unplugged to drain the water through drainage pipe 210.

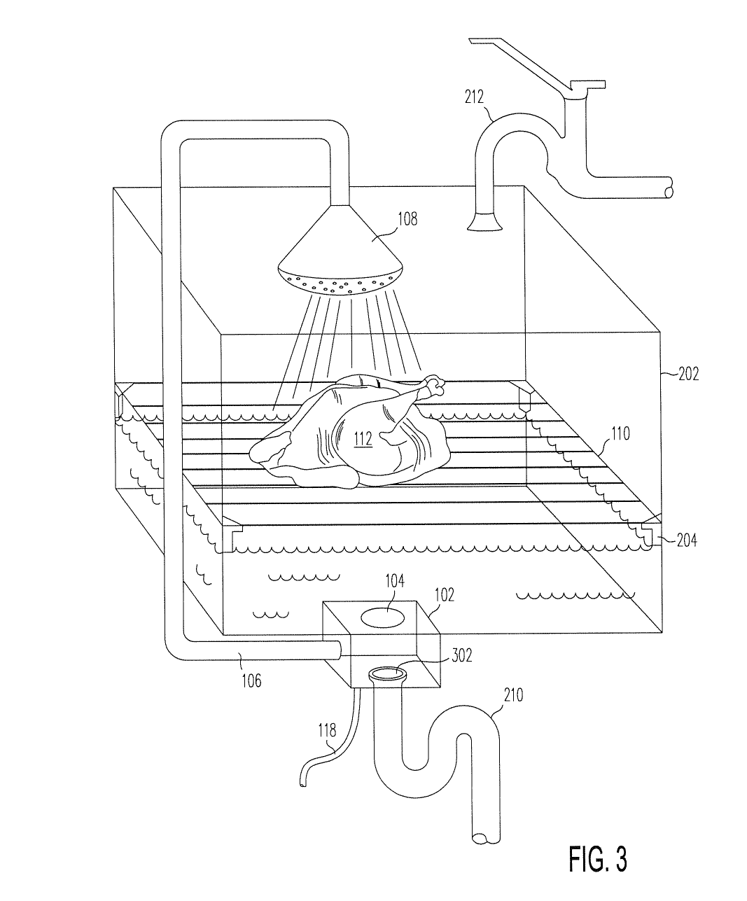

FIG. 3 shows a perspective view of a recirculating water defroster that is integrated with a tub to defrost food placed on a grate where the water pump is located outside the tub in accordance with one embodiment of the present invention. In contrast to FIG. 2, water pump 102 is attached to the outside of tub 202. Tub 202 has an opening that is aligned with inlet hole 104 of water pump 102 to supply water collected in tub 202 to water pump 102.

Water pump 102 has a drainage opening 302 that is hooked up to drainage pipe 210. During the operation of water pump 102 or when filling tub 202 with water before the start of operation, drainage opening 302 may be closed. After the completion of the defrosting operation, drainage opening 302 may be opened to drain the water through drainage pipe 210. The closing and opening of water pump 102 may be controlled from a control panel affixed to water pump 102. In one or more embodiments, the control panel may be located on the outside of tub 202 separate from water pump 102. Thus, the recirculating water defroster of FIG. 3 offers the added functionality of controlling the drainage of the water from tub 202 through water pump 102. In one or more embodiments, water pump 102 may function as a garbage disposal unit to ground larger food particles suspended in water when draining water from tub 202.

Water pump 106 may have a filtration system. Power cord 118 supplies electrical power to operate water pump 102. Water pipe 106 connects to water pump 102 through an outlet opening in water pump 102. In one or more embodiments, water pump 102 may have multiple outlet openings to connect with multiple water pipes 106. Spout 108, grate 110, and welds 204 may be configured to operate as previously described. Thus, water pump 102 recirculates water collected in tub 202 through inlet hole 104, up through water pipe 106 and out through spout 108 to defrost food 112 placed on grate 110. A control panel located on water pump 102 or separate from it may be used to control the operation of water pump 102 such as to turn it on/off, and to control the pump speed, duration, opening/closing of drainage opening 302, etc.

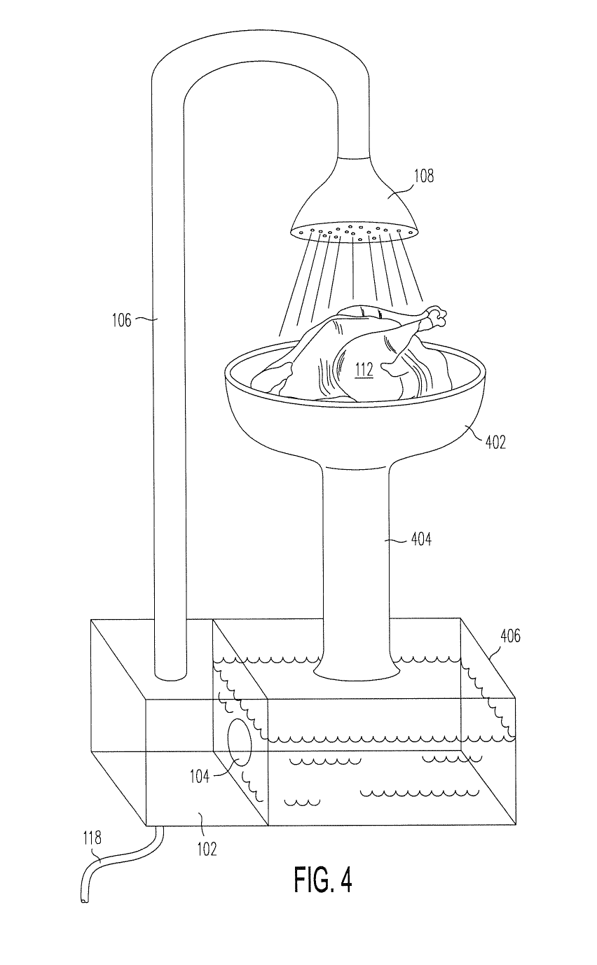

FIG. 4 shows a perspective view of a recirculating water defroster that integrates the food placement unit and the water pump in a portable unit to defrost food placed in the food placement unit in accordance with one embodiment of the present invention. A food placemen unit has a cradle 402 that holds food 112, a neck 404, and a bottom chamber 406 that may serve as a tub or a reservoir. Bottom chamber 406 is connected to water pump 102 through inlet hole 104. Water collected in bottom chamber 406 is taken up through inlet hole 104, pumped by water pump 102 through water pipe 106 and out through spout 108 to defrost food 112. Water washes over food 112 in cradle 402, drains down neck 404, collects in bottom chamber 406 and is taken up again through inlet hole 104 to be recirculated. Cradle 402 and neck 404 of food placement unit may be detached from bottom chamber 406 to configure the food placement unit with cradles 402 of different shapes and sizes for holding different food.

Before a defrosting operation, bottom chamber 406 may be partially filled with cold tap water. After a defrosting operation, cradle 402 and neck 404 of food placement unit may be removed and water pump 102 may be run to pump water out through spout 108 to empty water from bottom chamber 406. Power cord 118 supplies electrical power to water pump 102. In one or more embodiments, a control panel located on water pump 102 or separate from it may be used to control the operation of water pump 102 such as to turn it on/off, and to control the pump speed, duration. In one or more embodiments, bottom chamber 406 may be detached from water pump 102 to configure the bottom chamber 406 for different water holding capacities. Advantageously, the food placement unit, water pump 102 and the water dispenser unit are integrated into a compact and portable recirculating water defroster unit.

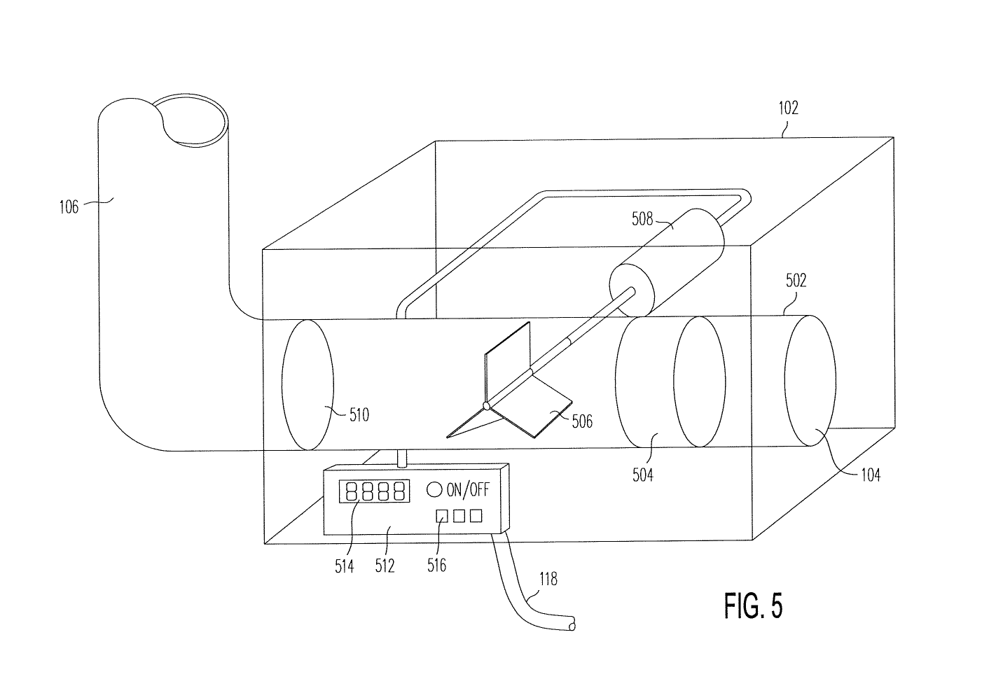

FIG. 5 shows components of water pump 102 of a recirculating water defroster in accordance with one embodiment of the present invention. Water pump 102 has inlet hole 104 for water intake. Water taken in from inlet hole 104 flows through a tube 502 and is filtered by a filtration device 504. Filtration device 504 may filter out food particles, food wrappings, other organic/inorganic compounds, or other impurities. Filtration device 504 may comprise of one or more carbon filters, reverse osmosis filters, ion filters, or various other types of filters. Filtered water is pumped by a turbine 506 driven by a motor 508. Motor 508 may be an AC, DC, or various types of electrical motors. Water is pumped through outlet hole 510 located at the opposite opening of tube 502 and out to water pipe 106. In one or more embodiments, tube 502 may connect with a drainage opening used for draining waste water. Such water pump 102 with a drainage opening may be found in the recirculating water defroster of FIG. 3. The drainage opening may be closed or opened by operating a valve through a control panel 512. In one or more embodiments, tube 502 may have multiple outlet holes 510 to connect with multiple water pipes 106.

Control panel 512 may be located on water pump 102 or may be located separate from water pump 102 if water pump 102 is submerged in water as in FIG. 1 or FIG. 2. Control panel 512 has a display 514 for displaying the operating status of the recirculating water defroster. Touch sensors 516 on control panel 512 allows a user to turn on/off motor 508, to control the pump speed, to program the length of operation of water pump 102, to open/close valves, or to otherwise control the operation of the recirculating water defroster. Control signals from control panel 512 may be transmitted to motor 508 and to other parts of water pump 102 through cables or may be transmitted wirelessly. Power cord 118 supplies electrical power to power motor 508 and control panel 512. In one or more embodiments, control panel 512 may operate as a remote control running on battery power.

The recirculating water system as described may be used in applications other than for defrosting food. For example, it may be used for recirculating water for spray misting of produce in grocery markets, for rinsing ice cream scoops in ice cream stores, to cool off heated cutting blades of saws, or to cool machineries or equipment in other industrial applications

The above detailed description is provided to illustrate specific embodiments of the present invention and is not intended to be limiting. Numerous modifications and variations within the scope of the present invention are possible. For example, the water pump may be embedded into the water dispenser unit or into the food placement unit. The present invention is set forth in the accompanying claims.

We claim:

1. A recirculating water defroster, comprising:
a water pump that includes an inlet and an outlet, wherein the water pump is adapted to pump water taken in from the inlet to the outlet; and
a water dispenser unit that includes an opening to dispense water, wherein the water dispenser unit is coupled to the outlet of the water pump to deliver the water pumped from the water pump to the opening;
an object placement unit adapted to hold an object to receive the water dispensed from the water dispenser unit, wherein the object placement unit holds the object above a water level so that water runs over the object and wherein the water is collected and provided to the inlet of the water pump to be recirculated.

2. The recirculating water defroster of claim 1, wherein the water dispenser unit is detachable from the outlet of the water pump.

3. The recirculating water defroster of claim 1, wherein the water dispenser unit comprises:
a pipe with a first end and a second end, wherein the first end of the pipe is coupled to the outlet of the water pump; and
a spout coupled to the second end of the pipe, wherein the spout includes the opening to dispense the water.

4. The recirculating water defroster of claim 3, wherein the spout is configured to dispense the water in one of a plurality of spray patterns.

5. The recirculating water defroster of claim 1, wherein the recirculating water defroster is placed in a tub, and wherein the tub collects the water to be recirculated.

6. The recirculating water defroster of claim 1, wherein a height of the object placement unit is adjustable.

7. The recirculating water defroster of claim 1, wherein the water pump comprises a filtration system configured to filter the water taken in from the inlet.

8. The recirculation water defroster of claim 1, further comprising a control panel, wherein the control panel has one or more controls adapted to control an operation of the water pump.

9. The recirculation water defroster of claim 8, wherein one of the controls of the control panel is adapted to control a speed of the water pump.

10. The recirculating water defroster of claim 1, further comprising a tub, wherein the tub collects the water to be recirculated.

11. The recirculating water defroster of claim 10, wherein the water pump is placed inside the tub to allow the water pump to take in the water collected in the tub through the inlet.

12. The recirculating water defroster of claim 10, wherein the tub has one or more support fixtures and wherein the object placement unit is supported by the support fixtures inside the tub.

13. The recirculating water defroster of claim 12, wherein the support fixtures are adjustable to adjust the height of the object placement unit to hold the object above the water level.

14. The recirculating water defroster of claim 10, wherein the tub comprises a drainage opening that is adapted to drain the collected water from the tub.

15. The recirculating water defroster of claim 10, wherein the water pump is placed outside the tub.

16. The recirculating water defroster of claim 15, wherein the tub comprises an opening that is aligned with the inlet of the water pump, and wherein the collected water in the tub is supplied to the inlet of the water pump through the opening.

17. The recirculating water defroster of claim 16, wherein the water pump further comprises a drainage opening adapted to drain the collected water from the tub.

18. The recirculating water defroster of claim 1, wherein the object placement unit is integrated with the water pump to allow the water to be provided from the object placement unit through the inlet of the water pump for recirculation.

19. The recirculating water defroster of claim 18, wherein the object placement unit includes a reservoir adapted to collect the water to be provided to the inlet of the water pump.

20. The recirculating water defroster of claim 18, wherein the object placement unit is detachable from the water pump.
